(19) United States
(12) Patent Application Publication
(10) Pub. No.: US 2026/0024944 A1
(43) Pub. Date: Jan. 22, 2026

(54) CHARGING CONNECTOR ASSEMBLY WITH A REPLACEABLE ELECTRICAL TERMINAL

(71) Applicant: Aptiv Technologies AG, Schaffhausen (CH)

(72) Inventors: Nathan Hando, Warren, OH (US); Jonathan Weidner, Conneautville, PA (US); David Peterson, Aurora, OH (US); James Hamilton, Youngstown, OH (US); William Guthrie, Youngstown, OH (US); Nicholas Durse, Youngstown, OH (US)

(21) Appl. No.: 18/777,041

(22) Filed: Jul. 18, 2024

(51) Int. Cl. H01R 13/623; B60L 53/16; H01R 13/639; H01R 24/20

(52) U.S. Cl. CPC H01R 13/623; H01R 13/639; H01R 24/20; B60L 53/16

(57) ABSTRACT

The present invention discloses a charging connector assembly designed for an electrical energy transfer system. The assembly includes an electrical conductor with a threaded attachment feature and an electrical terminal with a base having a corresponding threaded attachment feature to engage and disengage the conductor's threaded feature directly. The terminal also features a torque feature that can be operated by a tool to rotate the terminal, enhancing installation and removal. The torque feature is conveniently accessible from a user-facing surface of the charging connector assembly when installed, providing ease of removal and replacement of the terminal when needed.

### TECHNICAL FIELD

The subject matter disclosed herein relates to charging connector assemblies, such as a vehicle charging inlet, and, in particular, to a charging connector assembly with a replaceable electrical terminal.

### BACKGROUND

In order to charge a battery of an electric vehicle (EV) or hybrid electric vehicle (HEV), the vehicle is provided with a charging connector assembly, typically referred to as a charging inlet assembly. A corresponding charging connector assembly, such as those on a charging cable of an electric vehicle charger, is configured to be mated with the charging inlet assembly. Terminals are held in a receptacle connector of a housing of the charging connector assembly. The terminals extend through channels in the housing into a chamber at the rear of the housing for connection to corresponding power cables. The terminals may suffer from long term durability due to harsh operating environments. For example, the terminals are provided at an exterior of the vehicle, and are thus exposed to the environment, such as to debris, moisture and other contaminants. Additionally, the charging connector may introduce contaminants when plugged onto the charging inlet assembly. The high currents experienced by the terminal during charging may lead to aggressive abrasion over the life of the terminal, which causes increased contact resistance, power loss, and excessive heating. Corrosion or other damage to the terminal typically requires replacement of the entire cable harness in order to service the terminals. This may lead to expensive and time consuming repair. The charging connector assembly needs to be disassembled from the vehicle to access the cable harness for replacement, which is time-consuming and requires professional service technicians.

Terminals in charging connector assembly are generally mounted in a direction from the inside toward the outside. This arrangement typically requires removal of the charging connector assembly from vehicle in order to service or replace the electrical terminals due to mechanical wear and electrical degradation through use that may increase operating temperature and required charging time required.

A need remains for a charging connector assembly that may be manufactured and serviced in a cost effective manner and provides long-term reliability.

### SUMMARY

In some aspects, the techniques described herein relate to a charging connector assembly configured for use in an electrical energy transfer system. The electrical energy transfer system includes an electrical conductor defining a threaded attachment feature and an electrical terminal having a base defining a corresponding threaded attachment feature configured to engage and disengage the threaded attachment feature of the electrical conductor. The corresponding threaded attachment feature is configured to directly attach the terminal to the electrical conductor. The terminal defines a torque feature configured to cooperate with a tool to facilitate rotation of the terminal. The torque feature is accessible by the tool from a user accessible face of the charging connector assembly when installed.

In some aspects, the techniques described herein relate to a replaceable electrical terminal configured for use in a charging connector assembly of an electrical energy transfer system. The terminal includes a threaded attachment feature configured to be directly connected to an electrical conductor within the charging connector assembly by a corresponding threaded attachment feature of the electrical conductor and a torque feature configured to cooperate with a tool to facilitate rotation of the terminal. The torque feature is accessible by the tool from a user accessible face of the charging connector assembly when installed.

### BRIEF DESCRIPTION OF THE DRAWINGS

FIG. 1 is an isometric view of a charging connector assembly according to some embodiments.

FIG. 2 is an exploded view of a terminal, housing, and electrical conductor of the charging connector assembly of FIG. 1 according to some embodiments.

FIG. 3 is a rear isometric view of the terminal according to some embodiments.

FIG. 4 is an isometric view of a tool used to rotate the terminal according to some embodiments.

FIG. 5 is a rear isometric view of the housing and electrical conductor of FIG. 2 according to some embodiments.

FIG. 6 is an isometric view of an alternative terminal according to some embodiments.

FIG. 7 is an isometric view of an alternative electrical conductor according to some embodiments.

FIG. 8 is an isometric view of another alternative electrical conductor according to some embodiments.

FIG. 9 is an isometric view of yet another alternative electrical conductor according to some embodiments.

FIG. 10 is a front isometric view of an alternative terminal according to some embodiments.

FIG. 11 is a chart of different socket types disposed in a tip of the terminal according to some embodiments.

### DETAILED DESCRIPTION

The present disclosure describes a charging connector assembly having replaceable electrical terminals. The charging connector assembly may be used as a charging inlet assembly.

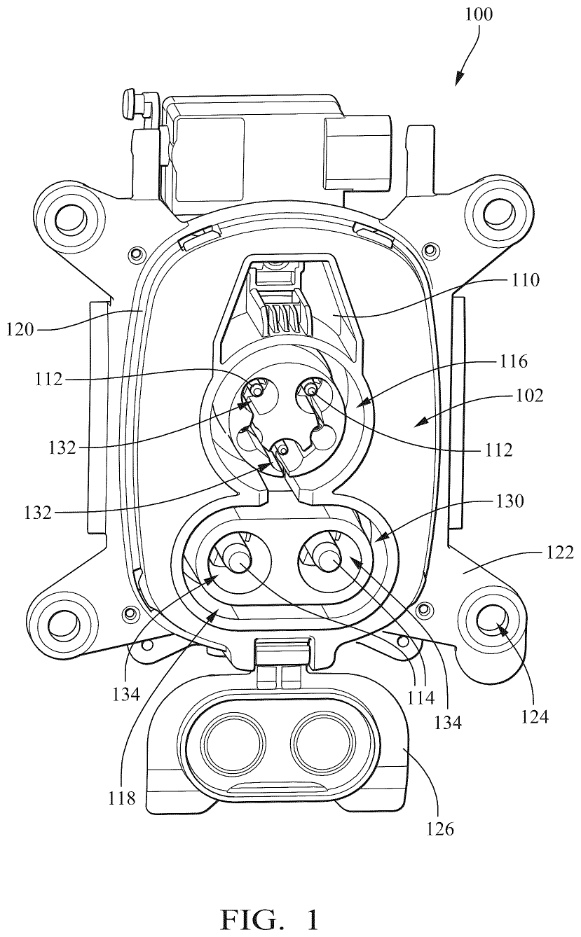

FIG. 1 is a front isometric view of a charging connector assembly in accordance with an some embodiments, e.g., a charging inlet assembly 100. The charging inlet assembly 100 may be used as a charging inlet for a vehicle, such as an electric vehicle (EV) or hybrid electric vehicle (HEV). The charging inlet assembly 100 includes a receptacle connector 102 that is configured to mate with a corresponding charging connector (not shown). In this illustrated example, the receptacle connector 102 is configured for mating with AC charging connectors and DC fast charging connectors, such as the CCS-2 SAE J1772 charging connector. Other embodiments may be envisioned for other charging connector types, such as NACS charging connector.

The charging inlet assembly 100 includes a housing 110 in which terminals 112 and terminals 114 are disposed. The housing 110 defines the receptacle connector 102. The terminals 112, 114 form part of the receptacle connector 102 and are configured to be mated to the corresponding charging connector. In this example, the terminals 112 are AC terminals and the terminals 114 are DC terminals. The terminals 112 are arranged in a first connector port. 116 of the receptacle connector 102 and the terminals 114 are arranged in a second connector port 118 of the receptacle connector 102.

The charging inlet assembly 100 includes a mounting flange 120 that is attached to the housing 110. The mounting flange 120 is used to fix the charging inlet assembly 100 to the vehicle. The mounting flange 120 includes mounting tabs 122 having openings 124 that receive fasteners (not shown) which are used to secure the charging inlet assembly 100 to the vehicle. Other types of mounting features may be used to secure the charging inlet assembly 100 to the vehicle. The mounting flange 120 may also include a seal between the charging inlet assembly 100 and the vehicle.

The charging inlet assembly 100 includes a cover 126 which may be attached by a hinge to the mounting flange 120 and/or the housing 110. The cover 126 is used to cover the second connector port 118. FIG. 1 illustrates this cover 126 in an open position.

In this example, the housing 110 includes sockets 130 at a front of the housing 110 that receive the charging connector. The housing 110 includes AC terminal cavities 132 in which the AC terminals 112 are disposed and DC terminal cavities 134 in which the DC terminals 114 are disposed. The AC terminal cavities 132 are provided by the first connector port. 116. The DC terminal cavities 134 are provided by the second connector port 118. The AC and DC terminals 112, 114 are formed of an electrically conductive material, such as copper.

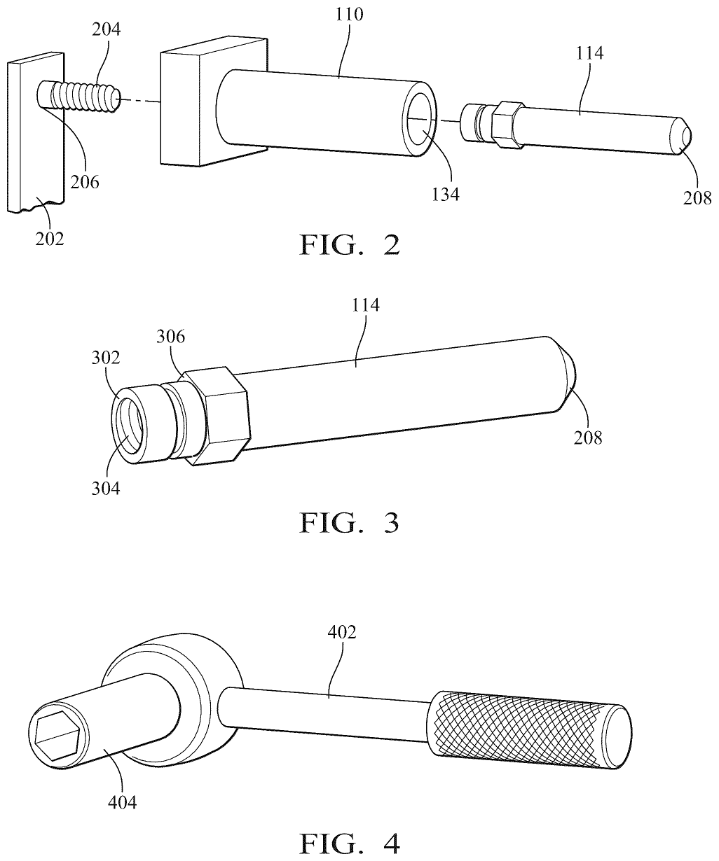

FIG. 2 shows an exploded partial isometric view of the housing 110, particularly the second connector port 118. The DC terminal 114 is received within the DC terminal cavity 134 from a user accessible face of the housing 110, e.g., the face of the housing 110 in FIG. 1 to which the cover 126 is attached. A threaded attachment feature 204 extending from an electrical conductor 202 to which the DC terminal 114 is attached is received within the DC terminal cavity 134 from a user non-accessible face of the housing 110 opposite the user accessible face that is normally inaccessible to the user. In this illustrated example, the electrical conductor is a rigid electrical busbar 202 having a generally rectangular cross section. The busbar 202 may be formed of a copper-based or aluminum-based material. The treaded attachment feature 204 in this example includes a threaded stud that is configured to provide rational resistance relative to the busbar 202. As shown in FIG. 3, a base 302 of the DC terminal 114 includes a corresponding threaded attachment feature 304 the DC terminal 114 in the form of a threaded bore that is configured to receive the threaded stud 204, thereby securing the DC terminal 114 to the busbar 202 and within the DC terminal cavity 134.

As also shown in FIG. 3, the DC terminal 114 defines a torque feature 306 near the base of the DC terminal 114 that is configured to cooperate with a tool, such as a ratcheting socket wrench 402 shown in FIG. 4, to facilitate rotation of the DC terminal 114 for connection to the busbar 202 and installation of the DC terminal 114 in the DC terminal cavity 134 or for disconnection from the busbar 202 and removal of the DC terminal 114 from the DC terminal cavity 134. In the illustrated example, the torque feature 306 comprises a prismatic shape, e.g., a hexagonal prism having a distance between opposed outer surfaces of the torque feature which is greater than a distance between opposed outer surfaces of the terminal. The torque feature 306 may be sized to be accepted by a socket 404 of the ratcheting socket wrench 402 of FIG. 4. The socket may be a standard SAE or metric hexagonal or 12 point socket. The socket wrench 402 may be used to rotated the socket to tighten or untighten the DC terminal 114 to the busbar 202. In alternative embodiments, the torque feature may have other prismatic shapes, such as a cube and square or pentagonal prism. These alternative embodiments may discourage nonqualified technicians from servicing the DC terminal 114 due to the need for a more specialized socket.

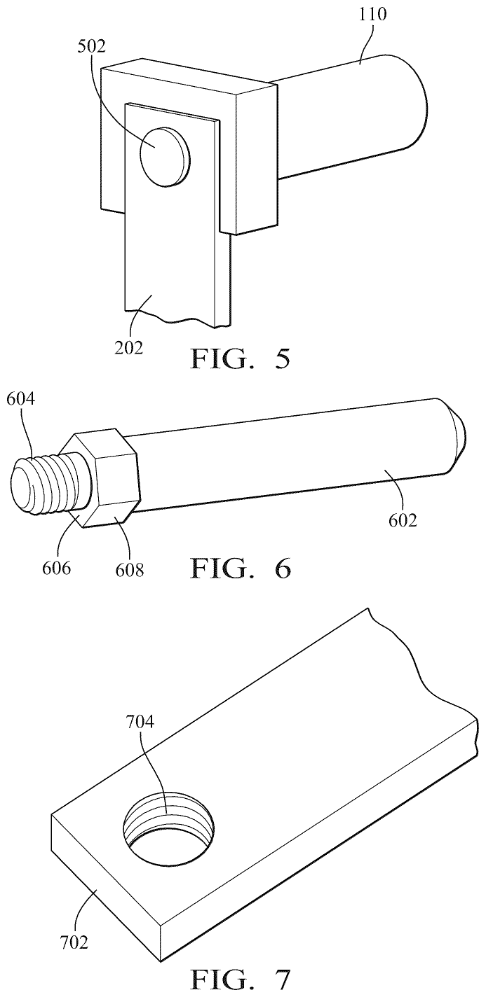

Returning to FIG. 2, the threaded stud 204 is held within a bore 206 in the busbar 202. As shown in FIG. 5 portion of the threaded stud 204 (not visible but extending away from shoulder 502) is in an interference or friction fit between the bore 206 and the threaded stud 204. In this example, the threaded stud 204 also defines a shoulder 502 that is configured to position the threaded stud 204 in a desired location within the bore 206. In other embodiments, the threaded stud may be ultrasonically welded to the surface of the busbar rather than held in a bore through the busbar.

The DC terminal 114 shown has a cylindrical male pin shape that is configured to be received within a corresponding female socket terminal of a corresponding electrical connector. The tip 208 of the DC terminal 114 may be tapered as best shown in FIG. 2 to facilitate entry of the DC terminal 114 into the corresponding socket terminal. The DC terminal 114 may be configured to conduct at least 200 amperes of electrical current.

In other embodiments, the DC terminal may have a female socket shape that is configured to accept a male pin terminal of a corresponding electrical connector.

While the description of the embodiments herein have focused on the DC terminal 114, other terminals such as the AC terminal 112 may be similarly configured for replaceability in the charging inlet assembly 100.

Alternative embodiments of the terminals and busbar are shown in FIGS. 6 and 7. As shown in FIG. 6, the alternative terminals 602 define a threaded stud 604 extending from the base 606 of the terminal 602 forming the torque feature 608. The threaded stud 604 is integrally formed with the base 606. As shown in FIG. 7, an alternative busbar 702 defines a corresponding threaded bore 704 in which the threaded stud 604 of the terminal 602 is received to secure the terminal 602 to the busbar 702 and within the terminal cavity 132, 134.

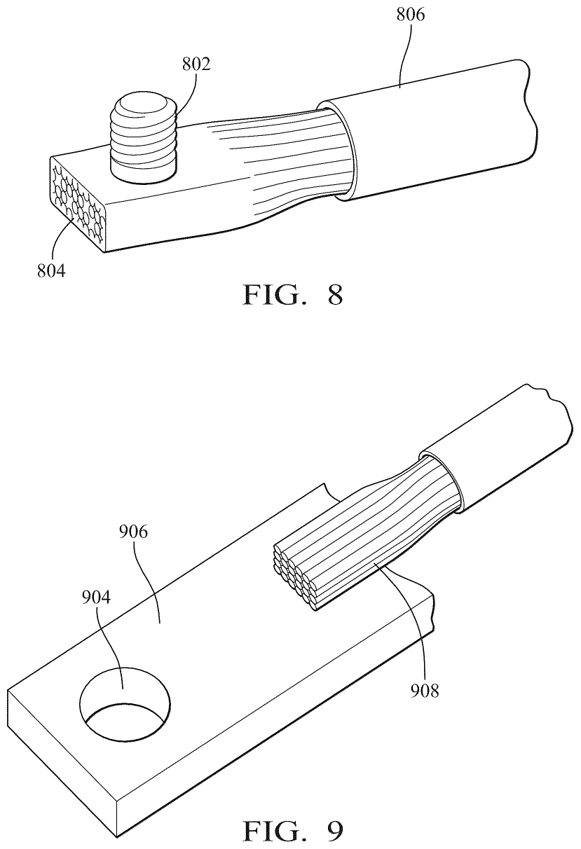

As shown in FIGS. 8 and 9, in alternative embodiments, the treaded attachment feature may be defined by an electrical conductor having a configuration other than a busbar. For example, as shown in FIG. 8, the threaded attachment feature 802 may be attached to an ultrasonically welded nugget 804 at an end of a stranded wire cable 806. As shown in FIG. 9, the threaded attachment feature may be attached to blank terminal 902 that is attached an end of a stranded wire cable 904, e.g., by ultrasonic welding. The blank terminal 902 defines a bore 906 that may be configured to be in an interference fit with the treaded attachment feature as shown in the example of FIG. 2 or the bore may be threaded as shown in the example of FIG. 7.

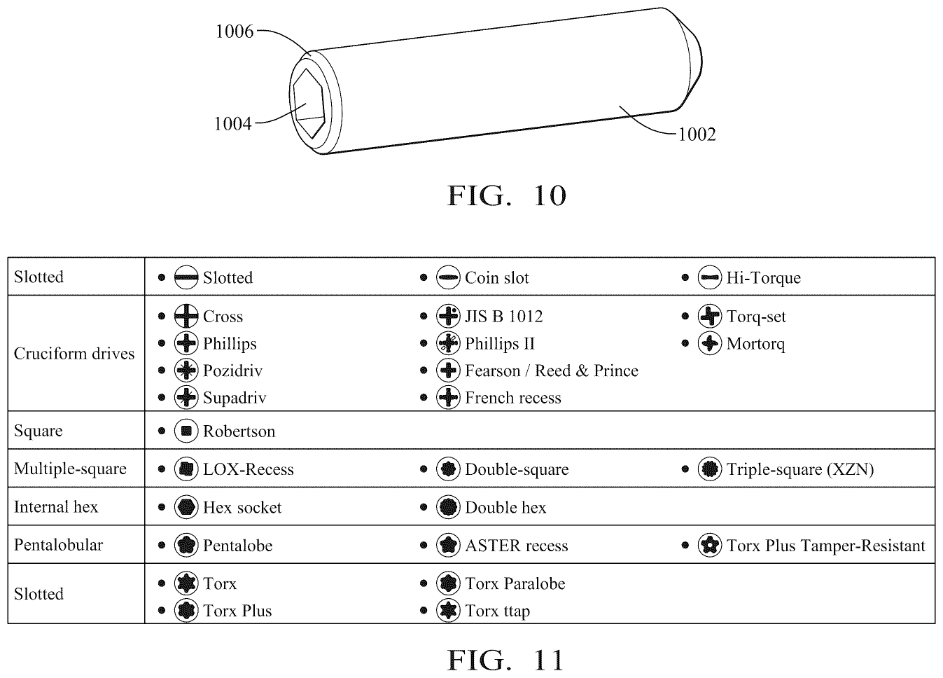

Another alternative embodiment of the terminal 1002 is shown in FIG. 10. In this embodiment the torque feature is a socket 1004 defined in a tip 1006 of the terminal rather than a prismatic structure near the base. A distance between the opposed inner surfaces of the torque feature is less than a diameter of the terminal 1002. The shape of the socket 1004 in the tip 1006 may be in the form of a slotted socket, a triangular socket, a square socket, a cruciform socket, a pentalobular socket, a hexagonal socket, or a hexalobular socket. A diagram of various socket types that may be employed is shown in FIG. 11.

Accordingly, a charging connector assembly that provides the benefits of replacing worn or damaged terminals without the need to disassemble and/or remove the charging connector assembly from its installed location is presented herein. While the example of the charging connector assembly

### Discussion of Possible Embodiments

The following are non-exclusive descriptions of possible embodiments of the present invention.

In some aspects, the techniques described herein relate to a charging connector assembly configured for use in an electrical energy transfer system. The electrical energy transfer system includes an electrical conductor defining a threaded attachment feature and an electrical terminal having a base defining a corresponding threaded attachment feature configured to engage and disengage the threaded attachment feature of the electrical conductor. The corresponding threaded attachment feature is configured to directly attach the terminal to the electrical conductor. The terminal defines a torque feature configured to cooperate with a tool to facilitate rotation of the terminal. The torque feature is accessible by the tool from a user accessible face of the charging connector assembly when installed.

The assembly of the preceding paragraph can optionally include, additionally and/or alternatively any, one or more of the following features/steps, configurations and/or additional components.

In some aspects, the techniques described herein relate to a charging connector assembly, wherein the electrical conductor includes a rigid busbar having a generally rectangular cross-section.

In some aspects, the techniques described herein relate to a charging connector assembly, wherein the threaded attachment feature of the busbar includes a threaded stud configured to provide rational resistance relative to the busbar and wherein the corresponding threaded attachment feature of the terminal includes a threaded bore.

In some aspects, the techniques described herein relate to a charging connector assembly, wherein a portion of the threaded stud is in an interference fit within a bore defined in the busbar.

In some aspects, the techniques described herein relate to a charging connector assembly, wherein the threaded attachment feature of the busbar includes a threaded bore and wherein the corresponding threaded attachment feature of the terminal includes a threaded stud.

In some aspects, the techniques described herein relate to a charging connector assembly, wherein the threaded stud is integrally formed with the terminal.

In some aspects, the techniques described herein relate to a charging connector assembly, wherein the torque feature is located near the base of the terminal, wherein the torque feature includes a prismatic shape, and wherein a distance between opposed outer surfaces of the torque feature is greater than a distance between opposed outer surfaces of the terminal.

In some aspects, the techniques described herein relate to a charging connector assembly, wherein the prismatic shape is a hexagonal prism.

In some aspects, the techniques described herein relate to a charging connector assembly, wherein the terminal has a cylindrical pin shape, wherein the torque feature includes a socket located in a tip of the pin terminal arranged opposite the base, and wherein a distance between opposed inner surfaces of the torque feature is less than a diameter of the terminal.

In some aspects, the techniques described herein relate to a charging connector assembly, wherein a shape of the socket is selected from a list consisting of a slotted socket, a triangular socket, a square socket, a cruciform socket, a pentalobular socket, a hexagonal socket, and a hexalobular socket.

In some aspects, the techniques described herein relate to a charging connector assembly, wherein the terminal has a cylindrical pin shape and wherein the terminal has a tip opposite the base that is integral with the terminal and is tapered.

In some aspects, the techniques described herein relate to a charging connector assembly, wherein the terminal is configured to conduct at least 200 amperes of electrical current.

In some aspects, the techniques described herein relate to a replaceable electrical terminal configured for use in a charging connector assembly of an electrical energy transfer system. The terminal includes a threaded attachment feature configured to be directly connected to an electrical conductor within the charging connector assembly by a corresponding threaded attachment feature of the electrical conductor and a torque feature configured to cooperate with a tool to facilitate rotation of the terminal. The torque feature is accessible by the tool from a user accessible face of the charging connector assembly when installed.

The terminal of the preceding paragraph can optionally include, additionally and/or alternatively any, one or more of the following features/steps, configurations and/or additional components.

In some aspects, the techniques described herein relate to a terminal, wherein the threaded attachment feature of the terminal includes a threaded bore.

In some aspects, the techniques described herein relate to a terminal, wherein the threaded attachment feature of the terminal includes a threaded stud.

In some aspects, the techniques described herein relate to a terminal, wherein the torque feature is located near the threaded attachment feature of the terminal, wherein the torque feature includes a prismatic shape, and wherein a distance between opposed outer surfaces of the torque feature is greater than a distance between opposed outer surfaces of the terminal.

In some aspects, the techniques described herein relate to a terminal, wherein the prismatic shape is a hexagonal prism.

In some aspects, the techniques described herein relate to a terminal, wherein the terminal has a cylindrical pin shape, wherein the torque feature is a socket located in a tip of the terminal opposite the threaded attachment feature of the terminal and wherein a distance between opposed inner surfaces of the torque feature is less than a distance between opposed outer surfaces of the terminal.

In some aspects, the techniques described herein relate to a terminal, wherein a shape of the socket is selected from a list consisting of a slotted socket, a triangular socket, a square socket, a cruciform socket, a pentalobular socket, a hexagonal socket, and a hexalobular socket.

In some aspects, the techniques described herein relate to a terminal, wherein the terminal has a cylindrical pin shape and wherein the terminal has a tip opposite the threaded attachment feature of the terminal that is integrally formed with the terminal and is tapered.

While the invention has been described with reference to an exemplary embodiment(s), it will be understood by those skilled in the art that various changes may be made, and equivalents may be substituted for elements thereof without departing from the scope of the invention. In addition, many modifications may be made to adapt a particular situation or material to the teachings of the invention without departing from the essential scope thereof. Therefore, it is intended that the invention is not limited to the disclosed embodiment(s), but that the invention will include all embodiments falling within the scope of the appended claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. A charging connector assembly configured for use in an electrical energy transfer system, comprising:
an electrical conductor defining a threaded attachment feature; and
an electrical terminal having a base defining a corresponding threaded attachment feature configured to engage and disengage the threaded attachment feature of the electrical conductor, the corresponding threaded attachment feature configured to directly attach the terminal to the electrical conductor, the terminal defining a torque feature configured to cooperate with a tool to facilitate rotation of the terminal, the torque feature being accessible by the tool from a user accessible face of the charging connector assembly when installed.

2. The charging connector assembly in accordance with claim 1, wherein the electrical conductor is selected from the list consisting of a rigid busbar having a generally rectangular cross-section, a stranded wire cable having a corresponding planar terminal attached to the stranded wire cable, and a stranded wire cable having compacted strands at an end of a stranded wire cable.

3. The charging connector assembly in accordance with claim 2, wherein the threaded attachment feature of the busbar comprises a threaded stud configured to provide rational resistance relative to the busbar and wherein the corresponding threaded attachment feature of the terminal comprises a threaded bore.

4. The charging connector assembly in accordance with claim 3, wherein a portion of the threaded stud is in an interference fit within a bore defined in the busbar.

5. The charging connector assembly in accordance with claim 2, wherein the threaded attachment feature of the busbar comprises a threaded bore and wherein the corresponding threaded attachment feature of the terminal comprises a threaded stud.

6. The charging connector assembly in accordance with claim 5, wherein the threaded stud is integrally formed with the terminal.

7. The charging connector assembly in accordance with claim 1, wherein the torque feature is located near the base of the terminal, wherein the torque feature comprises a prismatic shape, and wherein a distance between opposed outer surfaces of the torque feature is greater than a distance between opposed outer surfaces of the terminal.

8. The charging connector assembly in accordance with claim 7, wherein the prismatic shape is a hexagonal prism.

9. The charging connector assembly in accordance with claim 1, wherein the terminal has a cylindrical pin shape, wherein the torque feature comprises a socket located in a tip of the pin terminal arranged opposite the base, and wherein a distance between opposed inner surfaces of the torque feature is less than a diameter of the terminal.

10. The charging connector assembly in accordance with claim 9, wherein a shape of the socket is selected from a list consisting of a slotted socket, a triangular socket, a square socket, a cruciform socket, a pentalobular socket, a hexagonal socket, and a hexalobular socket.

11. The charging connector assembly in accordance with claim 1, wherein the terminal has a cylindrical pin shape and wherein the terminal has a tip opposite the base that is integral with the terminal and is tapered.

12. The charging connector assembly in accordance with claim 1, wherein the terminal is configured to conduct at least 200 amperes of electrical current.

13. A replaceable electrical terminal configured for use in a charging connector assembly of an electrical energy transfer system, the terminal comprising:
a threaded attachment feature configured to be directly connected to an electrical conductor within the charging connector assembly by a corresponding threaded attachment feature of the electrical conductor; and
a torque feature configured to cooperate with a tool to facilitate rotation of the terminal, the torque feature being accessible by the tool from a user accessible face of the charging connector assembly when installed.

14. The terminal in accordance with claim 13, wherein the threaded attachment feature of the terminal comprises a threaded bore.

15. The terminal in accordance with claim 13, wherein the threaded attachment feature of the terminal comprises a threaded stud.

16. The terminal in accordance with claim 13, wherein the torque feature is located near the threaded attachment feature of the terminal, wherein the torque feature comprises a prismatic shape, and wherein a distance between opposed outer surfaces of the torque feature is greater than a distance between opposed outer surfaces of the terminal.

17. The terminal in accordance with claim 16, wherein the prismatic shape is a hexagonal prism.

18. The terminal in accordance with claim 13, wherein the terminal has a cylindrical pin shape, wherein the torque feature is a socket located in a tip of the terminal opposite the threaded attachment feature of the terminal and wherein a distance between opposed inner surfaces of the torque feature is less than a distance between opposed outer surfaces of the terminal.

19. The terminal in accordance with claim 18, wherein a shape of the socket is selected from a list consisting of a slotted socket, a triangular socket, a square socket, a cruciform socket, a pentalobular socket, a hexagonal socket, and a hexalobular socket.

20. The terminal in accordance with claim 13, wherein the terminal has a cylindrical pin shape and wherein the terminal has a tip opposite the threaded attachment feature of the terminal that is integrally formed with the terminal and is tapered.
